(19) United States
(12) Patent Application Publication
(10) Pub. No.: US 2014/0195661 A1
(43) Pub. Date: Jul. 10, 2014

(54) Computer System Identification

(71) Applicant: INTERNATIONAL BUSINESS MACHINES CORPORATION, Armonk, NY (US)

(72) Inventor: Bashir Y. Moosani, Austin, TX (US)

(73) Assignee: INTERNATIONAL BUSINESS MACHINES CORPORATION, Armonk, NY (US)

(21) Appl. No.: 13/738,955

(22) Filed: Jan. 10, 2013

(51) Int. Cl. H04L 12/24

(52) U.S. Cl. CPC H04L 41/08
USPC 709/223

(57) ABSTRACT

According to one embodiment of the present disclosure, an approach is provided in which a computer system receives an internet protocol (IP) test message that includes an internet protocol (IP) address. The computer system compares the included IP address with the computer system's assigned IP address and, when the two IP addresses match, the computer system activates a visual indicator proximate to the computer system.

### BACKGROUND

The present disclosure relates a visual indication mechanism that identifies a computer system based upon the computer system's internet protocol (IP) address.

Data centers typically utilize a large number of computer systems that process information. The data centers may have multiple “equipment racks,” which stack several computer systems in a vertical manner and conserve floor space. At times, a system administrator may wish to physically locate a particular computer system. Although the system administrator typically identifies the computer system on a network by its internet protocol (IP) address, the system administrator may not know the physical location of the particular computer system, such as which equipment rack and/or which slot within an equipment rack the computer system resides.

### BRIEF SUMMARY

According to one embodiment of the present disclosure, an approach is provided in which a computer system receives an internet protocol (IP) test message that includes an internet protocol (IP) address. The computer system compares the included IP address with the computer system's assigned IP address and, when the two IP addresses match, the computer system activates a visual indicator proximate to the computer system.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a diagram showing a computer system activating a visual indicator in response to receiving internet control message protocol (ICMP) echo request that includes a matching internet protocol (IP) address;

FIG. 2 is a diagram showing an identification system sending an ICMP echo request that includes an IP subnet address;

FIG. 3 is a diagram showing a computer system matching an IP address include in an IP test message and providing a visual activation signal to a visual indicator;

FIG. 4 is a diagram showing a computer system detecting a matching IP address and providing a visual activation signal to an external visual indicator;

FIG. 5 is a flowchart showing steps taken in a computer system matching an IP address received in an IP test message and activating a visual indicator;

FIG. 6 is a block diagram of a data processing system in which the methods described herein can be implemented; and

FIG. 7 provides an extension of the information handling system environment shown in FIG. 6 to illustrate that the methods described herein can be performed on a wide variety of information handling systems which operate in a networked environment.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The following detailed description will generally follow the summary of the disclosure, as set forth above, further explaining and expanding the definitions of the various aspects and embodiments of the disclosure as necessary.

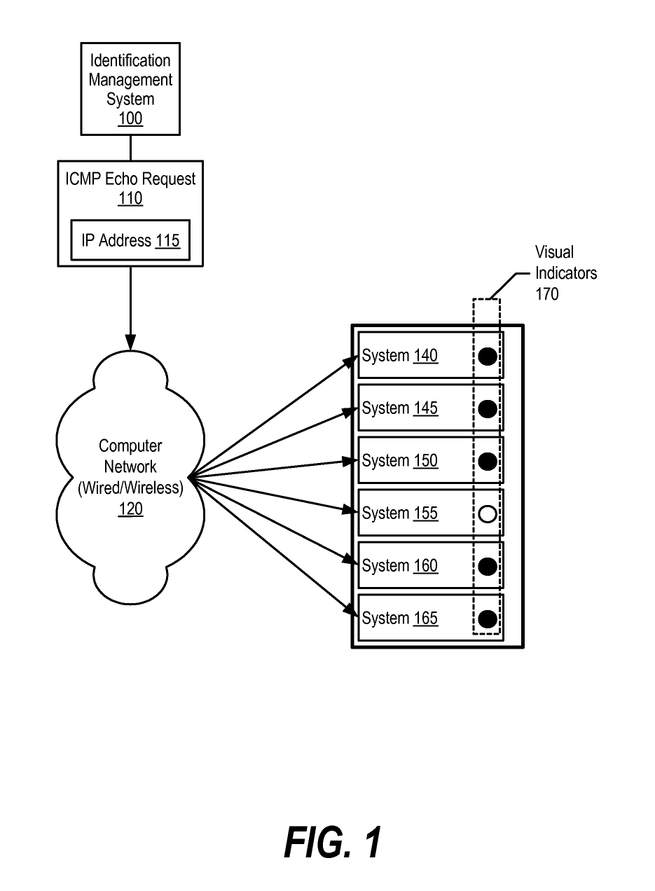

FIG. 1 is a diagram showing a computer system activating a visual indicator in response to receiving internet control message protocol (ICMP) echo request that includes a matching internet protocol (IP) address. A system administrator typically identifies a computer system on a network by the computer system's IP address. As those skilled in the art can appreciate, an IP address is a numerical label assigned to each device (e.g., computer, printer) participating in a computer network. Each device is assigned a unique IP address, which may be static in nature or dynamic in nature. Static IP addresses are manually assigned to a computer by an administrator. Dynamic IP addresses are frequently assigned on local area networks (LANs) and broadband networks by Dynamic Host Configuration Protocol (DHCP) servers and, in turn, IP addresses are dynamically assigned to devices as the devices join the computer network. In either case, IP addresses may be reassigned to different computer systems on an as-needed basis.

When a system administrator wishes to physically locate a computer system utilizing the computer system's IP address, the system administrator uses identification management system 100 to send an IP test message to “ping” the computer system. As those skilled in the art can appreciate, a “ping” is a utility used to test the reachability of a destination computer system on an Internet Protocol (IP) network. The ping utility creates an Internet Control Message Protocol (ICMP) echo request (ICMP echo request 110) that includes the destination computer system's IP address (IP address 115). The ping utility operates in several IP-based versions, including IPv4 and IPv6. In one embodiment, identification management system 100 may be an electronic device such as a laptop computer, a desktop computer, a tablet, a cell phone, and et cetera.

Computer network 120 distributes ICMP echo request 110 to each of computer systems 140-165. Computer network 120 may be a wired network, a wireless network, or a combination of a wired network and a wireless network. In one embodiment, computer network 120 includes routers and/or switches to route IP packets between computer systems.

Each of systems 140-165 include one of visual indicators 170, such as a light, which is activated (e.g., illuminated) when one of systems 140-165 matches its assigned IP address with IP address 115. The example shown in FIG. 1 shows that system 155's visual indicator 170 is activated (e.g., illuminating light), thus indicating that that system 155's IP address matches IP address 115 and allowing the system administrator to visually locate system 155.

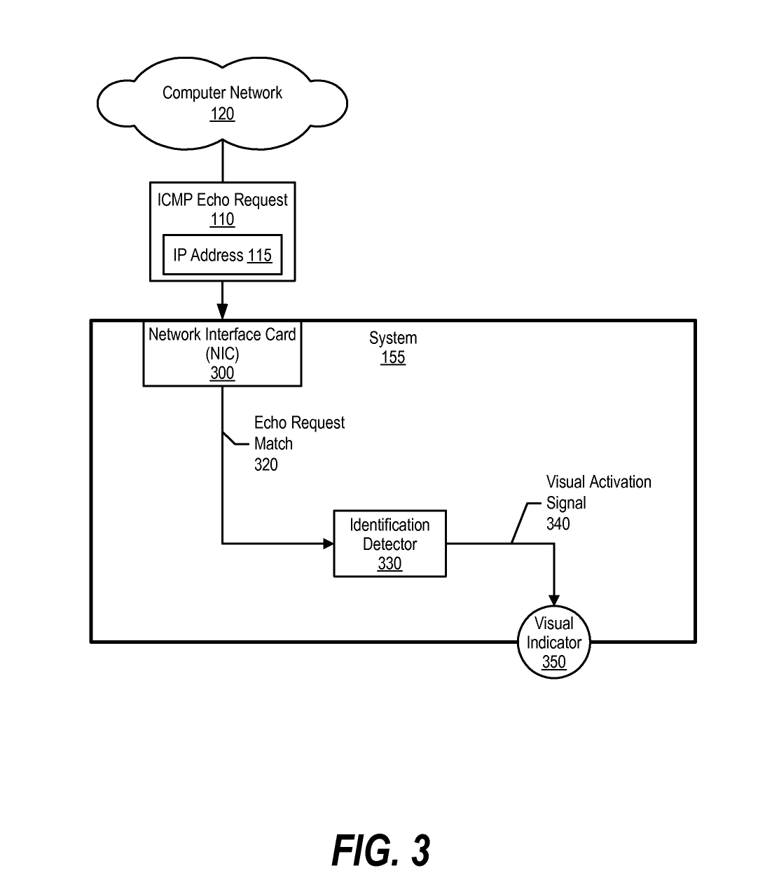

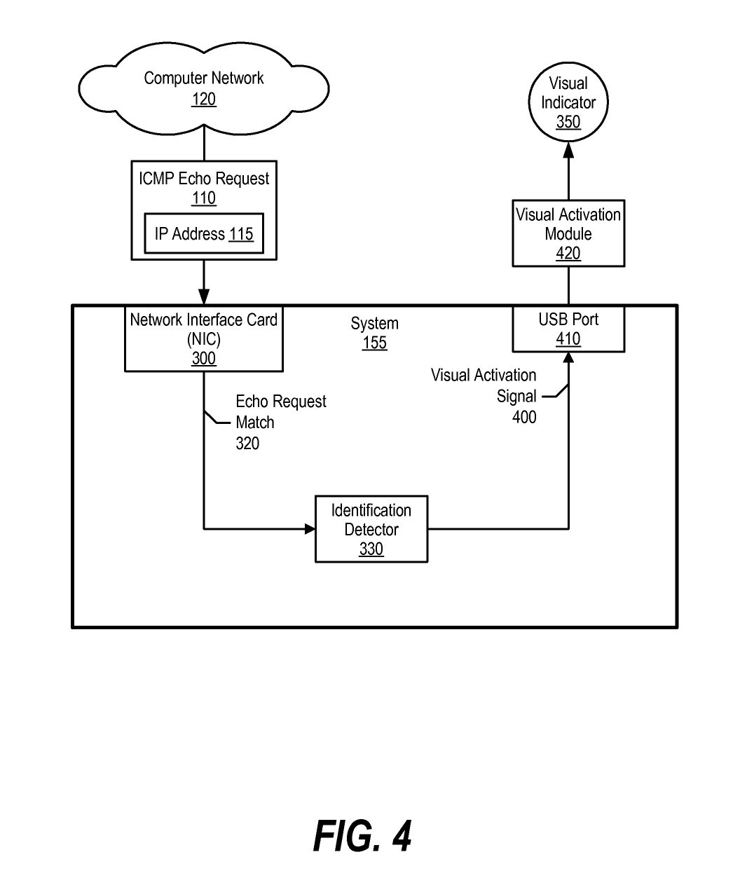

In one embodiment, visual indicators 170 are located on the front panels of systems 140-165 (see FIG. 3 and corresponding text for further details). In another embodiment, visual indicators 170 are external to systems 140-165 and receive visual activation signals through systems 140-165 external ports (e.g., USB port) (see FIG. 4 and corresponding text for further details).

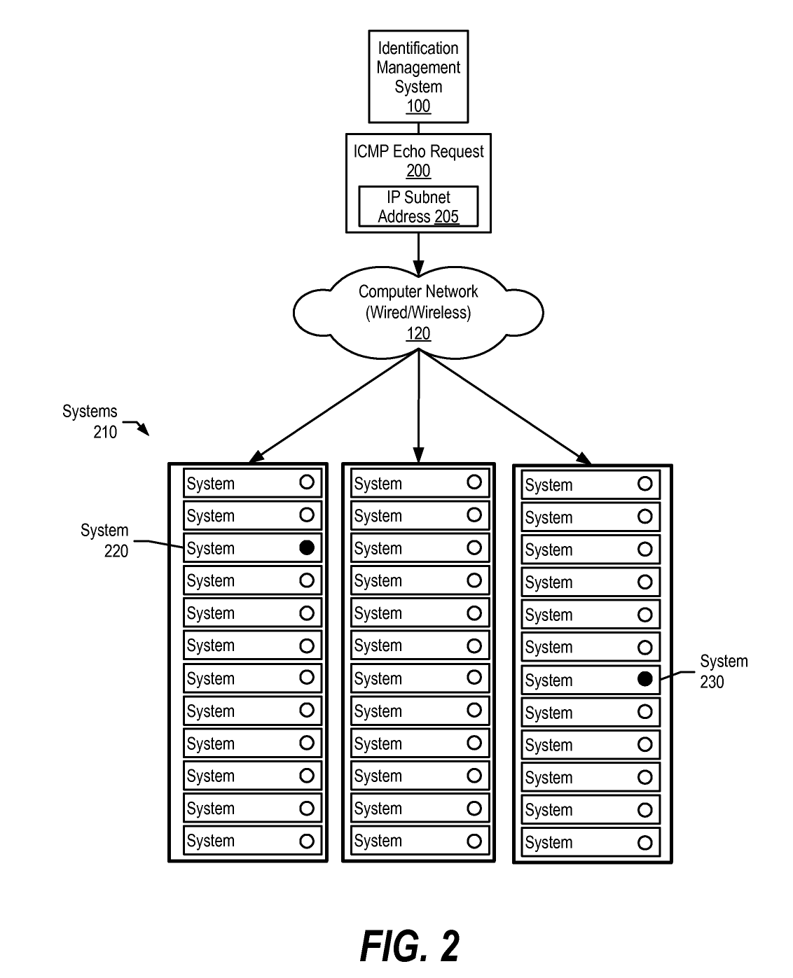

FIG. 2 is a diagram showing an identification management system sending an ICMP echo request that includes an IP subnet address over a computer network. In one embodiment, a user may wish to check network connectivity of a group of computer systems included on a particular subnet. As those skilled in the art can appreciate, a subnet, or subnetwork, is a logical subdivision of an IP network that has computers belonging to a particular subnet (e.g., 256 possible IP addresses) addressed with a common, identical, most-significant bit-group in their IP address.

Identification management system 100 creates ICMP echo request 200 and includes IP subnet address 205. In turn, computer system 120 distributes ICMP echo request 200 to each of systems 210. The example shown in FIG. 2 shows that each of systems 210's visual indicators are activated (white) with exception of system 220 and system 230 (dark indicators). As such, the system administrator is able to visually determine that systems 220 and 230 are not configured correctly (e.g., wrong IP addresses) or have a network connection issue (e.g., unplugged cable, malfunctioning network interface card, etc.).

FIG. 3 is a diagram showing a computer system matching an IP address include in an IP test message and providing a visual activation signal to a visual indicator. In one embodiment, visual indicator 350 is coupled to system 155, such as on the front panel of system 155.

Network interface card (NIC) 300 receives ICMP echo request 110 and matches IP address 115 with system 155's assigned IP address. When a match occurs, NIC 300 initiates echo request match 320, which feeds into identification detector 330. In turn, identification detector 330 activates visual activation signal 340 to illuminate visual indicator 350. For example, identification detector 330 may apply power to visual activation signal 340 and illuminate visual indicator 350. In one embodiment, identification detector 330 may be implemented in hardware, software, or a combination of hardware and software. In another embodiment, identification detector 330 may be implemented on NIC 300.

FIG. 4 is a diagram showing a computer system detecting a matching IP address and providing a visual activation signal to an external visual indicator. In one embodiment, visual indicator 350 is coupled to system 155 through a cable attached to one of system 155's external ports, such as USB port 410. As those skilled in the art can appreciate, one could implement the features discussed in this disclosure using other external ports such as a Firewire port, parallel port, serial port, etc.

Network interface card (NIC) 300 receives ICMP echo request 110 and matches IP address 115 with system 155's IP address. When a match occurs, NIC 300 initiates echo request match 320, which feeds into identification detector 330. Identification detector 330 activates visual activation signal 340, which is coupled to USB port 410. Visual activation module 420 is powered through USB port 410 and detects visual activation signal 400 being activated. In turn, visual activation module 420 activates visual indicator 350 (e.g., applies power).

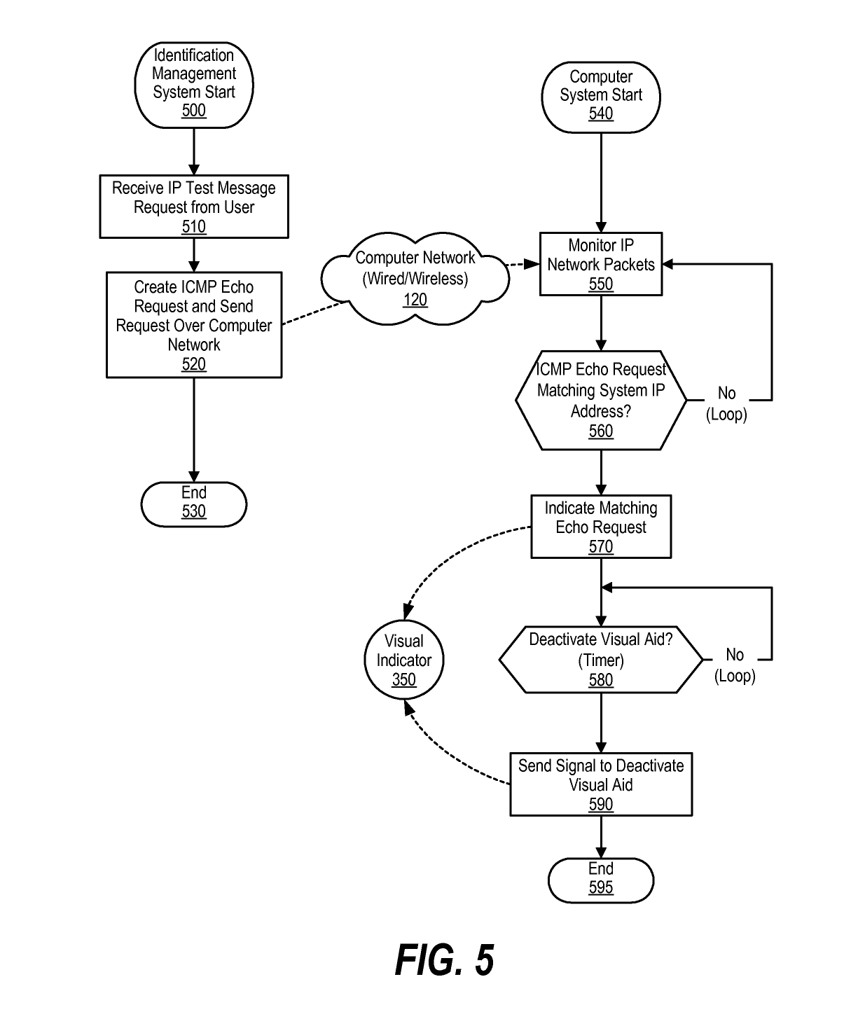

FIG. 5 is a flowchart showing steps taken in a computer system matching an IP address received in an IP test message and activating a visual indicator. Processing commences at 500, whereupon an identification management system (e.g., laptop computer) receives an IP test message request from a user (step 510). At step 520, the identification management system creates an IP test message (e.g., ICMP echo request) and sends the ICMP echo request over computer network 120. Identification management system processing ends at 530.

Computer system processing commences at 540, whereupon the computer system monitors IP network packets at step 550. A determination is made as to whether the computer system receives an IP test message whose embedded IP address matches the computer system's IP address (decision 560). If the computer system does not receive an IP test message that includes a matching IP address, decision 560 branches to the “No” branch, whereupon the computer system continues to monitor IP network packets.

This looping continues until the computer system matches a received IP address included in an IP test message with its corresponding IP address, at which point decision 560 branches to the “Yes” branch. In one embodiment, the computer system also determines whether its IP address is part of an IP subnet address included in an IP ping request (see FIG. 2 and corresponding text for further details).

At step 570, the computer system sends a visual activation signal to visual indicator 350. In one embodiment, the visual activation signal may be generated on the computer system's motherboard through a wire to a light installed on the computer system's front panel. In another embodiment, the visual activation signal may be generated on the computer system's motherboard and provided to an external port, such as a USB port. In this embodiment, an external module processes the visual activation signal and illuminates the visual indicator accordingly.

A determination is made as to whether to deactivate the visual indicator (decision 580). In one embodiment, the computer system sets a timer to activate the visual indicator. In another embodiment, the computer system may keep visual indicator 350 activated until a user depresses a “deactivation” button that is coupled to the computer system. Decision 580 loops through the “No” branch, until visual indicator 350 should be deactivated, at which point decision 580 branches to the “No” branch.

At step 590, the computer system sends a signal to deactivate visual indicator 350 and processing ends at 595.

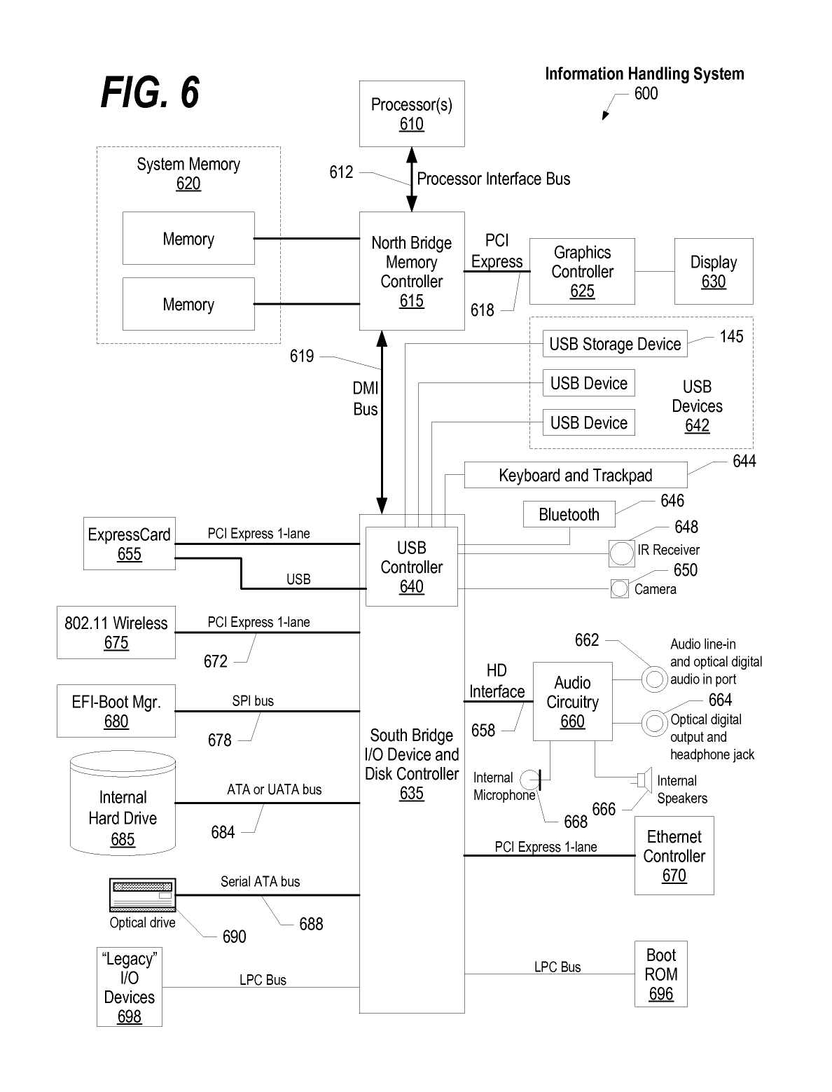

FIG. 6 illustrates information handling system 600, which is a simplified example of a computer system capable of performing the computing operations described herein. Information handling system 600 includes one or more processors 610 coupled to processor interface bus 612. Processor interface bus 612 connects processors 610 to Northbridge 615, which is also known as the Memory Controller Hub (MCH). Northbridge 615 connects to system memory 620 and provides a means for processor(s) 610 to access the system memory. Graphics controller 625 also connects to Northbridge 615. In one embodiment, PCI Express bus 618 connects Northbridge 615 to graphics controller 625. Graphics controller 625 connects to display device 630, such as a computer monitor.

Northbridge 615 and Southbridge 635 connect to each other using bus 619. In one embodiment, the bus is a Direct Media Interface (DMI) bus that transfers data at high speeds in each direction between Northbridge 615 and Southbridge 635. In another embodiment, a Peripheral Component Interconnect (PCI) bus connects the Northbridge and the Southbridge. Southbridge 635, also known as the I/O Controller Hub (ICH) is a chip that generally implements capabilities that operate at slower speeds than the capabilities provided by the Northbridge. Southbridge 635 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 696 and “legacy” I/O devices (using a “super I/O” chip). The “legacy” I/O devices (698) can include, for example, serial and parallel ports, keyboard, mouse, and/or a floppy disk controller. The LPC bus also connects Southbridge 635 to Trusted Platform Module (TPM) 695. Other components often included in Southbridge 635 include a Direct Memory Access (DMA) controller, a Programmable Interrupt Controller (PIC), and a storage device controller, which connects Southbridge 635 to nonvolatile storage device 685, such as a hard disk drive, using bus 684.

ExpressCard 655 is a slot that connects hot-pluggable devices to the information handling system. ExpressCard 655 supports both PCI Express and USB connectivity as it connects to Southbridge 635 using both the Universal Serial Bus (USB) the PCI Express bus. Southbridge 635 includes USB Controller 640 that provides USB connectivity to devices that connect to the USB. These devices include webcam (camera) 650, infrared (IR) receiver 648, keyboard and trackpad 644, and Bluetooth device 646, which provides for wireless personal area networks (PANs). USB Controller 640 also provides USB connectivity to other miscellaneous USB connected devices 642, such as a mouse, removable nonvolatile storage device 645, modems, network cards, ISDN connectors, fax, printers, USB hubs, and many other types of USB connected devices. While removable nonvolatile storage device 645 is shown as a USB-connected device, removable nonvolatile storage device 645 could be connected using a different interface, such as a Firewire interface, et cetera.

Wireless Local Area Network (LAN) device 675 connects to Southbridge 635 via the PCI or PCI Express bus 672. LAN device 675 typically implements one of the IEEE 802.11 standards of over-the-air modulation techniques that all use the same protocol to wireless communicate between information handling system 600 and another computer system or device. Optical storage device 690 connects to Southbridge 635 using Serial ATA (SATA) bus 688. Serial ATA adapters and devices communicate over a high-speed serial link. The Serial ATA bus also connects Southbridge 635 to other forms of storage devices, such as hard disk drives. Audio circuitry 660, such as a sound card, connects to Southbridge 635 via bus 658. Audio circuitry 660 also provides functionality such as audio line-in and optical digital audio in port 662, optical digital output and headphone jack 664, internal speakers 666, and internal microphone 668. Ethernet controller 670 connects to Southbridge 635 using a bus, such as the PCI or PCI Express bus. Ethernet controller 670 connects information handling system 600 to a computer network, such as a Local Area Network (LAN), the Internet, and other public and private computer networks.

While FIG. 6 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

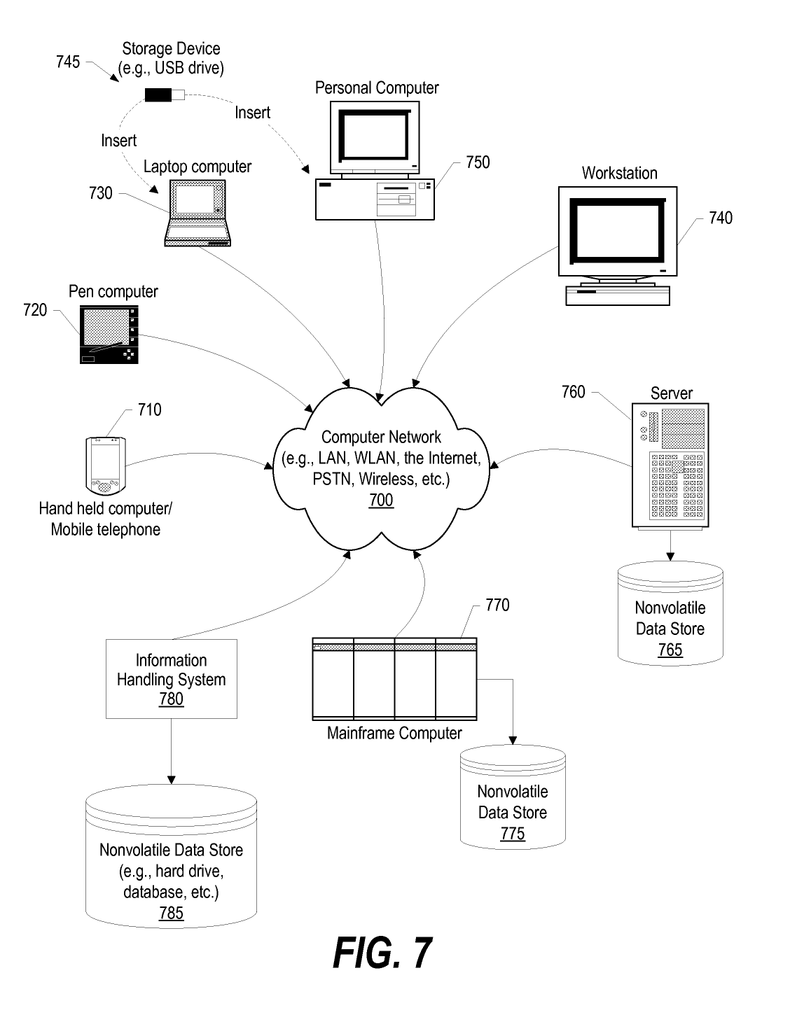

FIG. 7 provides an extension of the information handling system environment shown in FIG. 6 to illustrate that the methods described herein can be performed on a wide variety of information handling systems that operate in a networked environment. Types of information handling systems range from small handheld devices, such as handheld computer/mobile telephone 710 to large mainframe systems, such as mainframe computer 770. Examples of handheld computer 710 include personal digital assistants (PDAs), personal entertainment devices, such as MP3 players, portable televisions, and compact disc players. Other examples of information handling systems include pen, or tablet, computer 720, laptop, or notebook, computer 730, workstation 740, personal computer system 750, and server 760. Other types of information handling systems that are not individually shown in FIG. 7 are represented by information handling system 780. As shown, the various information handling systems can be networked together using computer network 700. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 7 depicts separate nonvolatile data stores (server 760 utilizes nonvolatile data store 765, mainframe computer 770 utilizes nonvolatile data store 775, and information handling system 780 utilizes nonvolatile data store 785). The nonvolatile data store can be a component that is external to the various information handling systems or can be internal to one of the information handling systems. In addition, removable nonvolatile storage device 645 can be shared among two or more information handling systems using various techniques, such as connecting the removable nonvolatile storage device 645 to a USB port or other connector of the information handling systems.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method comprising:
receiving an internet protocol (IP) test message at a computer system, wherein the IP test message includes a first internet protocol (IP) address;
retrieving a second IP address that identifies the computer system;
determining that the first IP address matches the second IP address; and
activating a visual indicator proximate to the computer system in response to determining that the first IP address matches the second IP address.

2. The method of claim 1 wherein the IP test message is an internet control message protocol (ICMP) echo request.

3. The method of claim 1 wherein the determining that the first IP address matches the second IP address is performed internal to the computer system, the method further comprising:
generating a visual activation signal internal to the computer system; and
sending the visual activation signal to an external port located on the computer system, wherein the external port is adapted to provide the visual activation signal to an external visual activation module.

4. The method of claim 3 further comprising:
receiving, from the external port, the visual activation signal at the external visual activation module; and
performing the activation of the visual indicator by the external visual activation module in response to receiving the visual activation signal.

5. The method of claim 1 wherein the first IP address corresponds to a IP subnet, the method further comprising:
determining whether the second IP address is included in the IP subnet; and
activating the visual indicator in response to determining that the second IP address is included in the IP subnet.

6. The method of claim 5 wherein the IP test message is sent to a plurality of computer systems included in the subnet, and wherein a first one of the plurality of computer systems fails to activate a corresponding visual indicator in response to the first computer system having a faulty network connection.

7. The method of claim 1 further comprising:
changing the second IP address of the computer system to a third IP address;
assigning the second IP address to a different computer system;
receiving, at the different computer system, a different IP test message, wherein the IP test message includes the first internet protocol (IP) address; and
activating a different visual indicator proximate to the different computer system in response to determining that the first IP address matches the second IP address assigned to the different computer system.

8. The method of claim 1 further comprising:
determining whether a visual indicator timer has expired; and
deactivation the visual indicator in response to determining that the visual indicator has expired.

9. An information handling system comprising:
one or more processors;
a memory coupled to at least one of the processors;
a set of computer program instructions stored in the memory and executed by at least one of the processors in order to perform actions of:
receiving an internet protocol (IP) test message, wherein the IP test message includes a first internet protocol (IP) address;
retrieving a second IP address that identifies the information handling system;
determining that the first IP address matches the second IP address; and
activating a visual indicator proximate to the information handling system in response to determining that the first IP address matches the second IP address.

10. The information handling system of claim 9 wherein the IP test message is an internet control message protocol (ICMP) echo request.

11. The information handling system of claim 9 wherein the set of instructions, when executed by one or more of the processors, further performs actions of:
generating a visual activation signal internal to the information handling system;
sending the visual activation signal to an external port located on the information handling system, wherein the external port is adapted to provide the visual activation signal to an external visual activation module;
receiving, from the external port, the visual activation signal at the external visual activation module; and
performing the activation of the visual indicator by the external visual activation module in response to receiving the visual activation signal.

12. The information handling system of claim 9 wherein the first IP address corresponds to a IP subnet, and wherein the set of instructions, when executed by one or more of the processors, further performs actions of:
determining whether the second IP address is included in the IP subnet; and
activating the visual indicator in response to determining that the second IP address is included in the IP subnet.

13. The information handling system of claim 12 wherein the IP test message is sent to a plurality of information handling systems included in the subnet, and wherein a first one of the plurality of information handling systems fails to activate a corresponding visual indicator in response to the first information handling systems having a faulty network connection.

14. The information handling system of claim 9 wherein the set of instructions, when executed by one or more of the processors, further performs actions of:
determining whether a visual indicator timer has expired; and
deactivation the visual indicator in response to determining that the visual indicator has expired.

15. A computer program product stored in a computer readable storage medium, comprising computer program code that, when executed by an information handling system, causes the information handling system to perform actions comprising:
receiving an internet protocol (IP) test message, wherein the IP test message includes a first internet protocol (IP) address;
retrieving a second IP address that identifies the information handling system;
determining that the first IP address matches the second IP address; and
activating a visual indicator proximate to the information handling system in response to determining that the first IP address matches the second IP address.

16. The computer program product of claim 15 wherein the IP test message is an internet control message protocol (ICMP) echo request.

17. The computer program product of claim 15 wherein the computer program code, when executed by the information handling system, cause the information handling system to further performs actions of:
generating a visual activation signal internal to the information handling system;
sending the visual activation signal to an external port located on the information handling system, wherein the external port is adapted to provide the visual activation signal to an external visual activation module;
receiving, from the external port, the visual activation signal at the external visual activation module; and
performing the activation of the visual indicator by the external visual activation module in response to receiving the visual activation signal.

18. The computer program product of claim 15 wherein the first IP address corresponds to a IP subnet, and wherein the computer program code, when executed by the information handling system, cause the information handling system to further performs actions of:
determining whether the second IP address is included in the IP subnet; and
activating the visual indicator in response to determining that the second IP address is included in the IP subnet.

19. The computer program product of claim 18 wherein the IP test message is sent to a plurality of information handling systems included in the subnet, and wherein a first one of the plurality of information handling systems fails to activate a corresponding visual indicator in response to the first information handling systems having a faulty network connection.

20. The computer program product of claim 15 wherein the computer program code, when executed by the information handling system, cause the information handling system to further performs actions of:
determining whether a visual indicator timer has expired; and
deactivation the visual indicator in response to determining that the visual indicator has expired.
